(19) United States
(12) Patent Application Publication
(10) Pub. No.: US 2014/0094274 A1
(43) Pub. Date: Apr. 3, 2014

(54) SYSTEMS, METHODS AND DEVICES FOR PLAYING WAGERING GAMES WITH SIMULTANEOUS REAL-TIME EVENTS AFFECTING THE WAGERING GAMES

(71) Applicant: WMS GAMING INC., Waukegan, IL (US)

(72) Inventors: Andrew C. Guinn, Chicago, IL (US); Jeremie D. Moll, Chicago, IL (US); Thomas R. Wood, Tucson, AZ (US); Damon E. Gura, Chicago, IL (US); Brian C. Marrant, Glendale Heights, IL (US)

(73) Assignee: WMS Gaming Inc., Waukegan, IL (US)

(21) Appl. No.: 13/772,566

(22) Filed: Feb. 21, 2013

Related U.S. Application Data
(60) Provisional application No. 61/707,470, filed on Sep. 28, 2012.

(51) Int. Cl. G07F 17/32

(52) U.S. Cl. CPC G07F 17/3244
USPC 463/25

(57) ABSTRACT

Gaming devices, gaming systems, methods of conducting wagering games, and computer programs for executing wagering games are disclosed. A gaming system for playing a wagering game is disclosed which includes one or more display devices, one or more input devices, one or more processors, and one or more memory devices. The memory device(s) stores instructions that, when executed by the processor(s), cause the gaming system to: simultaneously display the wagering game and a real-time event; randomly determine an outcome of the wagering game; identify a selected incident occurring in the real-time event, the occurrence of which is not controlled by the player or the gaming system; associate the selected incident with a parameter of the wagering game; and, upon occurrence of the selected incident in the real-time event during the simultaneous display of the wagering game and the real-time event, modify the parameter for a play of the wagering game.

### CLAIM OF PRIORITY AND CROSS-REFERENCE TO RELATED APPLICATION

This application claims the benefit of and priority to U.S. Provisional Patent Application No. 61/707,470, which was filed on Sep. 28, 2012, and is incorporated herein by reference in its entirety.

### COPYRIGHT

A portion of the disclosure of this patent document contains material which is subject to copyright protection. The copyright owner has no objection to the facsimile reproduction by anyone of the patent disclosure as it appears in the U.S. Patent and Trademark Office patent files or records, but otherwise reserves all copyright rights whatsoever.

### TECHNICAL FIELD

The present disclosure relates generally to wagering games, as well as wagering game terminals and wagering game systems. More particularly, the present disclosure relates to systems, methods and devices for playing wagering games affected by real-time events.

### BACKGROUND

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Thus, gaming manufacturers continuously strive to develop new games and improved gaming enhancements that will attract frequent play and increased player loyalty through enhanced entertainment value to the player.

There are three primary types of wagering game machines: mechanical, electromechanical, and electronic. The original slot machine, for example, was entirely mechanical in construction, working on an elaborate configuration of springs, gears, shafts, brakes and levers. Since its introduction in the early 1960's, the electromechanical slot machine began replacing most, if not all, mechanical slot machines. Electromechanical gaming machines typically use one or more microprocessors to determine a random outcome for each play of the slot game. Electrical stepper motors are then used to spin and stop a set of mechanical reels to reveal the slot-game outcome. The electronic gaming machine (EGM), in comparison, subsequently supplanted the mechanical reels of the electromechanical gaming machine with simulated mechanical reels generated by a video display device. Like its electromechanical counterpart, EGM's typically use one or more microprocessors to randomly determine an outcome for each play of the wagering game. Regardless of machine type, the wagering game outcomes are generally not influenced by real-time events occurring remotely from the gaming establishment.

While some current game features provide some enhanced excitement, there is still a need for additional concepts to enhance the entertainment value of electronic wagering games, such as slots, keno, poker, and blackjack. Although a lot of focus is now being paid to enhancing bonus games, there is still a lot of room for improving the base game and other aspects of wagering games. There is also a need for new gameplay features for base games, bonus games, progressive games, and the like, which influence the outcome of the wagering game in new and exciting ways. Such new features for wagering games will further enhance player entertainment, perpetuate player loyalty, and thus increase game play and profitability.

### SUMMARY

Disclosed herein are wagering games in which simultaneously displayed real-time events initiate or alter gameplay. Aspects of the present disclosure are directed to a wagering game, such as an electronic slot or poker game, that is tied to a real-time event, such as a live sporting game or television show, such that certain predefined occurrences in the real-time event triggers modifications to the wagering game. In a soccer game embodiment, for example, the wagering game can be configured such that every time a selected soccer player touches the ball during a live game, a symbol associated with that player becomes a wild symbol. Optionally, the player can also select specific real-time events within the game (e.g., a player scoring a touchdown while the reels of a slot game are spinning) to trigger a bonus game, a community game, a progressive jackpot, etc.

Incidents occurring in the real-time event can be probabilistically weighted to determine which features in the wagering game they can trigger. Continuing with the soccer game example, a goalie scoring during a live game has a very low probability; as such, a selected goalie scoring during a live soccer game can have a relatively large payoff potential in the wagering game (e.g., trigger a large progressive jackpot). In comparison, the probability that the center midfielder will score a goal is comparatively high; as such, a selected midfielder scoring during a live soccer game can have a relatively low payoff potential in the wagering game (e.g., enhance the payout for a low-probability winning symbol combination). Some embodiments may require a player to place an additional wager, beyond what has been wagered in the base wagering game, to bet on a particular team or on the occurrence of a selected incident to enable this feature.

According to one aspect of the present disclosure, a gaming system for a player to play a wagering game is disclosed. The gaming system includes one or more display devices, one or more input devices, one or more processors, and one or more memory devices. The one or more memory devices store instructions that, when executed by at least one of the one or more processors, cause the gaming system to: simultaneously display, via at least one of the one or more display devices, the wagering game and a real-time event; randomly determine an outcome of the wagering game; identify at least one selected incident occurring in the real-time event, occurrence of the at least one selected incident in the real-time event not being controlled by the player or the gaming system; associate the at least one selected incident with at least one parameter of the wagering game; and, upon occurrence of the at least one selected incident in the real-time event during the simultaneous display of the wagering game and the real-time event, modify the at least one parameter for at least one play of the wagering game.

In accordance with another aspect of the present disclosure, one or more physical machine-readable storage media are featured that includes instructions which, when executed by one or more processors, cause the one or more processors to perform operations comprising: direct one or more display devices to simultaneously display a wagering game and a real-time event; receive an indication of a wager from a player to play the wagering game; randomly determine an outcome of the wagering game; identify a selected incident occurring in the real-time event, occurrence of the selected incident in the real-time event not being controlled by the player or the one or more processors; associate the selected incident with a parameter of the wagering game; and, upon occurrence of the selected incident in the real-time event during the simultaneous display of the wagering game and the real-time event, modify the parameter for a play of the wagering game.

In accordance with yet another aspect of the disclosure, a computer-implemented method of conducting a wagering on a gaming system is presented. The method includes: simultaneously displaying, via at least one of one or more display devices, a wagering game and a real-time event; receiving an indication of a wager from a player to play the wagering game; randomly determining, via at least one of one or more processors, an outcome of the wagering game; identifying at least one selected incident occurring in the real-time event, occurrence of the at least one selected incident in the real-time event not being controlled by the player or the gaming system; associating the at least one selected incident with at least one parameter of the wagering game; and, upon occurrence of the at least one selected incident in the real-time event during the simultaneous display of the wagering game and the real-time event, modifying the at least one parameter for at least one play of the wagering game.

Another aspect of this disclosure is directed to a method of conducting a wagering on a gaming system with one or more processors and one or more display devices. The method includes: simultaneously displaying, via a single one of the display devices, the wagering game and the real-time event; randomly determining, via at least one of the one or more processors, an outcome of the wagering game, the wagering game having a parameter that affects the expected value of the wagering game; determining a probability of a selected incident occurring in the real-time event, occurrence of the selected incident in the real-time event not being controlled by the player or the one or more processors of the gaming system; associating the selected incident with the parameter of the wagering game if it is determined that the probability of the selected incident occurring in the real-time event is within a predetermined acceptable probability range for the parameter; and, responsive to an occurrence of the selected incident in the real-time event during the simultaneous display, modifying the wagering game parameter such that the expected value of the wagering game changes for a subsequent play of the wagering game.

Yet another aspect of this disclosure is directed to a method of conducting a wagering on a gaming system. The method includes: simultaneously displaying, via at least one of one or more display devices, the wagering game and a real-time event; receiving, via at least one of one or more input devices, an indication of a wager from a player to play the wagering game; randomly determining, via at least one of one or more processors, an outcome of the wagering game; receiving, via at least one of the one or more input devices, an indication of a second wager from a player to wager that a selected incident will occur in the real-time event, occurrence of the selected incident in the real-time event not being controlled by the player or the one or more processors of the gaming system; associating the selected incident with a parameter of the wagering game; and, responsive to an occurrence of the selected incident in the real-time event during the simultaneous display of the wagering game and the real-time event, modifying the parameter for a play of the wagering game.

The above summary is not intended to represent each embodiment or every aspect of the present disclosure. Rather, the summary merely provides an exemplification of some of the novel features presented herein. The above features and advantages, and other features and advantages of the present disclosure, will be readily apparent from the following detailed description of exemplary embodiments and modes for carrying out the present invention when taken in connection with the accompanying drawings and the appended claims.

### BRIEF DESCRIPTION OF THE DRAWINGS

FIG. 1 is a perspective-view illustration of an exemplary free-standing gaming terminal according to aspects of the present disclosure.

FIG. 2 is a schematic diagram of an example of a gaming system according to aspects of the present disclosure.

FIG. 3 is a screen shot of a representative basic-game screen of a wagering game displayed on a gaming terminal, gaming device, and/or gaming system according to aspects of the present disclosure.

FIG. 4 is a screen shot of a display device displaying a plurality of exemplary wagering games with a representative real-time event game feature in accordance with aspects of the present disclosure.

FIG. 5 is a screen shot of a display device displaying the wagering games and the real-time event game feature of FIG. 4 while the reels of the wagering games are spinning.

FIG. 6 is a screen shot of a display device displaying the wagering games and the real-time event game feature of FIG. 4 showing an outcome for each of the wagering games that has been affected by the occurrence of a selected incident in the real-time event.

FIG. 7 is a screen shot of a display device displaying another plurality of exemplary wagering games with another representative real-time event game feature in accordance with aspects of the present disclosure.

FIG. 8 is a flowchart for an exemplary method or algorithm that can correspond to instructions that can be stored on one or more non-transitory computer-readable media and can be executed by one or more controllers in accord with aspects of the disclosed concepts.

While aspects of this disclosure are susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the word “including” means “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

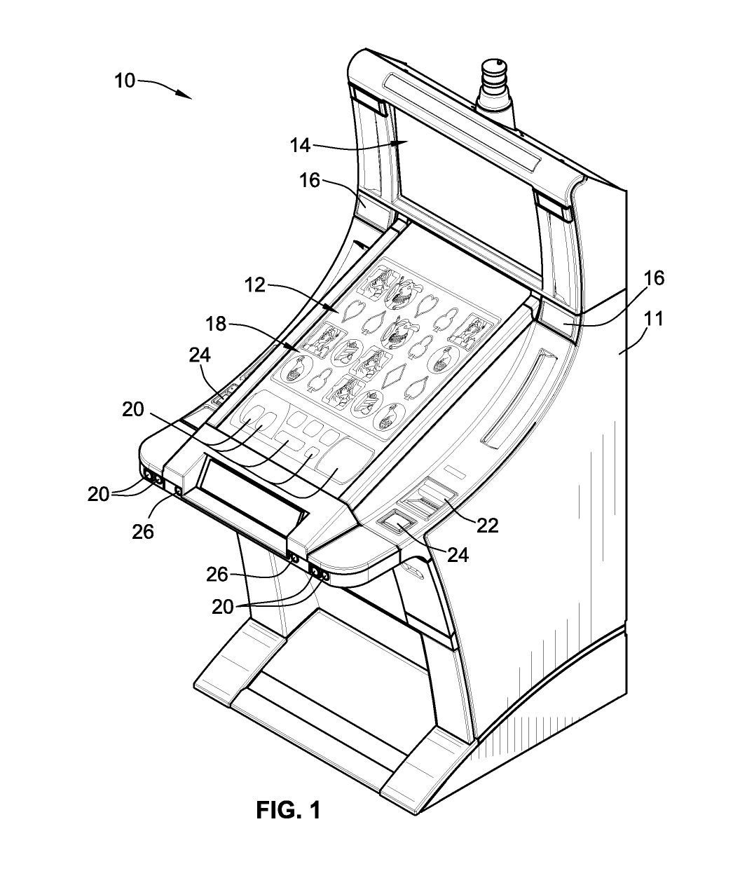

Referring to the drawings, wherein like reference numerals refer to like features throughout the several views, there is shown in FIG. 1 a representative gaming terminal 10 similar to those used in gaming establishments, such as casinos, hotels and cruise ships, and non-conventional gaming establishments, such as airports and restaurants. With regard to the present disclosure, the gaming terminal 10 (used herein interchangeably with “gaming machine” and “gaming device”) may be any type of wagering game device and may have varying structures and methods of operation. For example, in some aspects, the gaming terminal 10 is an electromechanical gaming terminal configured to play slots with mechanical reels, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models (as shown), handheld mobile devices, bartop models, workstation-type console models, personal computing devices, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433, U.S. Patent Application Publication Nos. 2010/0069160 and 2010/0234099, and International Application No. PCT/US2007/000792, all of which are incorporated herein by reference in their respective entireties for all purposes.

The gaming terminal 10 illustrated in FIG. 1 comprises a cabinet 11 that may house various input devices, output devices, and input/output devices. By way of non-limiting example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display may be disposed in front of the mechanical-reel display to portray a video image superimposed upon the mechanical-reel display. The display areas may variously display information associated with wagering games, non-wagering games, community games, progressive games, advertisements, services, premium entertainment, text messaging, emails, alerts, announcements, broadcast information, subscription information, etc., appropriate to the particular mode(s) of operation of the gaming terminal 10. The gaming terminal 10 includes a touchscreen(s) 18 mounted over the primary and/or secondary areas 12, 14, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals can be selected from a group consisting essentially of an electrical current, an electrical voltage, an electrical charge, an optical signal, an optical element, a magnetic signal, and a magnetic element.

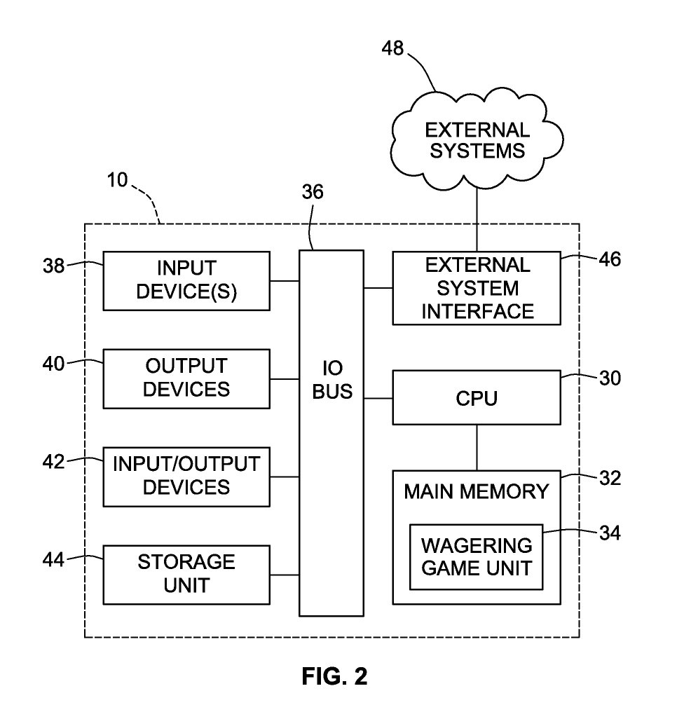

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks). In some embodiments, storage unit 44 stores performance data and/or configuration data.

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes a random number generator (RNG) for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

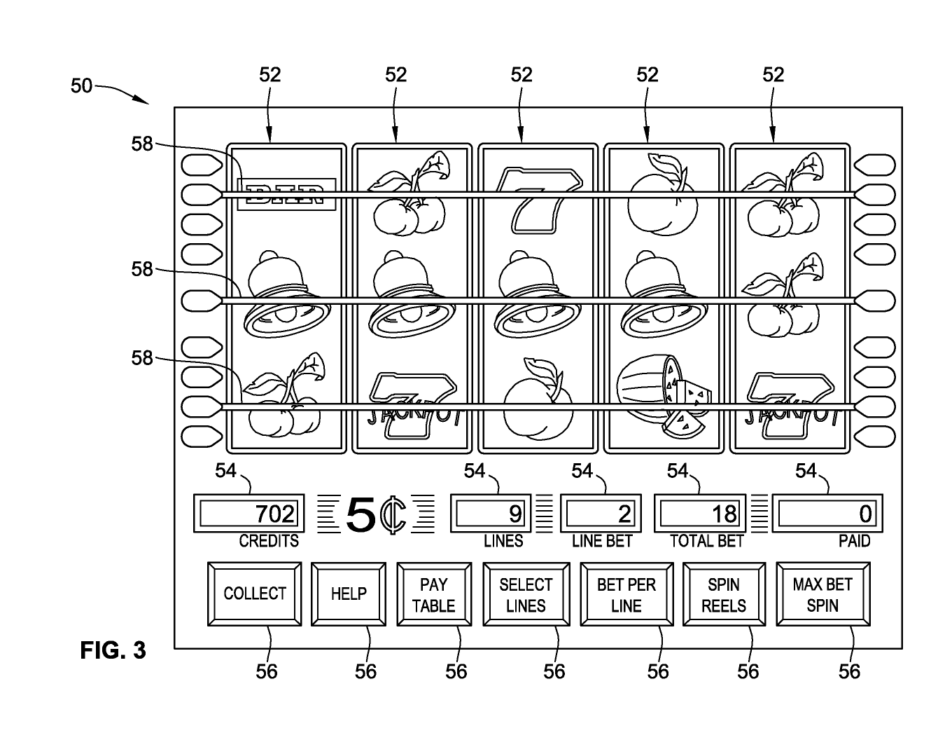

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by an RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

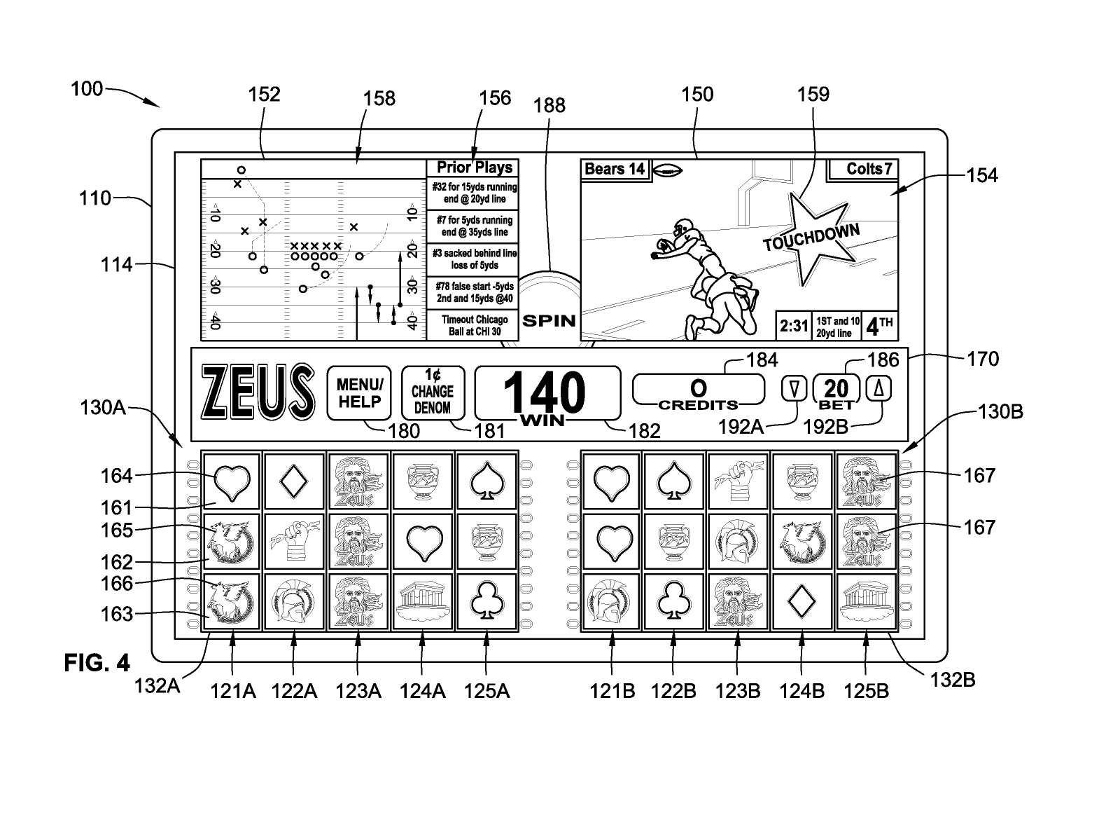

FIG. 4 is a screen shot of a game screen from an exemplary wagering game in accordance with aspects of the present disclosure. In particular, a primary display device 114 of a gaming machine or terminal 110, which may be part of an exemplary gaming system 100, is shown in FIG. 4. The gaming system 100 may be similarly configured to any known gaming system capable of providing the necessary functionality to practice the disclosed concepts, including the gaming system shown in FIG. 2. In this regard, the gaming terminal 110 can take on any of the various forms, optional configurations, and functional alternatives described herein and, thus, can be similar in function and connectivity to the gaming terminal 10 discussed above with respect to FIGS. 1 and 2. For instance, the gaming terminal 110 of FIG. 4 can take on various alternative configurations, including, without limitation, upright freestanding gaming machines, slant-top freestanding gaming machines, handheld and portable gaming machines, countertop gaming machines, personal computers and laptop computers, smartphones, or other known gaming devices, individually or in any combination thereof. Moreover, the primary display device 114 may be any form of video display capable of providing the necessary functionality to practice the disclosed concepts, such as those described with reference to the free-standing gaming terminal 10 of FIG. 1. For instance, the primary display device 114 may comprise a plasma, LED, OLED, LCD, CRT, projection, or transmissive display device or any other now-known or later-developed display device.

The primary display device 114 displays or otherwise visually depicts a plurality of wagering games, which in this example are first and second slot games 130A and 130B shown in FIG. 4. Each of the wagering games 130A, 130B comprises a respective plurality of symbol bearing reels 121A-125A and 121B-125B. Each reel 121A-125A, 121B-125B has a plurality of distinct symbol positions (collectively represented by the three symbol positions designated 161-163) and bearing a number of symbols (collectively represented by the three symbols designated 164-166). The symbols may include any variety of graphical symbols, emblems, elements, or representations, including symbols that are associated with one or more themes of the gaming terminal 110 and gaming system 100 (e.g., a ZEUS Greek Mythology theme). The symbols may also include a blank symbol or empty space. The symbols on the reels 121A-125A, 121B-125B are arranged in first and second arrays 132A and 132B, respectively, which in this embodiment are 3×5 matrices (i.e., three rows by five columns) of symbols. The reels 121A-125A, 121B-125B are varied (e.g., spun and stopped) to reveal combinations of symbols in the arrays 132A, 132B, which represent randomly selected outcomes of the wagering games 130A, 130B, that are evaluated for winning symbol combinations. Winning combinations of symbols landing, for example, on activated paylines (e.g., those paylines for which a wager has been received), cause awards to be paid in accordance with one or more pay tables associated with the gaming system 100.

Within the scope of this disclosure, the wagering games 130A and 130B can each include greater or fewer than five symbol-bearing reels (simulated, mechanical, or otherwise), each of which may include greater or fewer symbol positions than those shown in FIG. 4. In this regard, the randomly selected outcomes may comprise greater or fewer than 15 symbols, and may take on a variety of different forms having greater or fewer rows and/or columns. The matrix may even comprise other non-rectangular forms or arrangements of symbols. Moreover, the randomly selected outcomes of the wagering games 130A and 130B are merely representative in nature and therefore may be varied from the representation provided in FIG. 4. Likewise, the ZEUS game theme is purely illustrative and non-limiting in nature. Although most aspects of the wagering games 130A, 130B are all shown displayed on a single display device (i.e., the primary display device 114), these aspects are not so limited and can be displayed in any combination on any number of display devices unless otherwise expressly prohibited. However, it may be desirable in some preferred embodiments that many or all of these aspects and features be displayed via a single display device.

The primary display device 114 further includes certain display features for providing information and options to a player. According to the arrangement presented in FIG. 4, for example, a control bar 170 is displayed for presenting information to a player and for providing player-selectable options. For instance, the control bar 170 may include a MENU/HELP button 180, a WIN meter 182, a CREDITS meter 184, and a BET meter 586. The MENU/HELP button 180 can be pressed and activated (e.g., through an overlying touch screen) by a player desiring to access other control menus, preferences, help screens, informational menus, etc. For example, the player can change a theme of one or more of the wagering games 130A, 130B via the MENU/HELP button 180, or change the type of the wagering game (e.g., to video poker, keno, etc.). The WIN meter 182 displays to the player the amount of the total win (if any) from the most recent play of the wagering games 130A, 130B. The CREDITS meter 184 displays to the player the total amount of credits (if any) remaining and available to the player for play of the wagering games 130A, 130B. The BET meter 186 displays to a player the current size of his/her wager (in credits). Once a number of paylines are selected and a wager is placed, a SPIN button 188 can be pressed or otherwise activated by a player to effectuate rotation of the reels 121A-125A, 121B-125B. In an optional configuration, selection of the SPIN button 188 will automatically effectuate rotation of the reels 121A-125A, 121B-125B without requiring prior selection of a wager and/or a number of paylines (e.g., a default wager and a default number of payline(s) are automatically chosen upon selection of the SPIN button 188).

Fewer, additional, or alternative display features may be included for presenting information and/or options to a player. In one specific instance, a row of player-selectable LINES buttons can be provided to give players the option of quickly selecting and activating a predetermined number of paylines (e.g., 1, 5, 9, 20 or 40 lines). Another option would be to display a row of player-selectable PER LINE buttons, which gives a player the option of quickly selecting a predetermined bet per payline (e.g., 1, 2, 3, 5 and 10 credits per activated payline). The primary display device 114 can also include, for example, an optional CHANGE DENOM button 181 that can be activated to change the denomination of wagers (e.g., from 10 per credit to 250 per credit) which the player is inputting into the system 100. Other features may include, in some non-limiting examples, one or more bet change buttons 192A and 192B that permit a player to incrementally increase and/or decrease the size of his/her wager, as well as any of the other buttons and meters presented herein or otherwise now known or hereinafter developed.

For at least some embodiments, the single control bar 170 is operable to control aspects of both wagering games 130A and 130B. For instance, the wager presented in the BET meter 186 can be applied simultaneously to both wagering games 130A, 130B. In FIG. 4, for example, the control bar 170 can automatically apply 20 credits per active payline in the first wagering game 130A and 20 credits per active payline in the second wagering game 130B. In so doing, the player is not required to enter a separate wager for each of the wagering games 130A, 130B displayed on the primary display device 114. In this regard, pressing the SPIN button 188 once can be operable to activate both sets of reels 121A-125A, 121B-125B for concurrent or substantially concurrent play of the wagering games 130A, 130B. Optionally, for some optional embodiments, aspects of each wagering game 130A and 130B can be manipulated and modified independently. By way of example, the first sets of reels 121A-125A can be activated independently of the second set of reels 121B-125B, and vice versa. Likewise, the player may be given the option of making a separate wager for each of the wagering games 130A, 130B. The player can also be given the option of playing two completely different wagering games—e.g., electronic poker and electronic blackjack.

In some embodiments, the wagering games 130A, 130B are similar such that each wagering game 130A, 130B utilizes the same theme and the same type of symbols. For such embodiments, the wagering games 130A, 130B can be configured in the same way, for example, with the same number of available paylines, the same reel configurations, the same arrangement of rows and columns, the same pay table, the same rule sets, etc. In other embodiments, the wagering games 130A, 130B may be different in any or all of the foregoing aspects or other aspects. Moreover, in the embodiment shown in FIG. 4, the wagering games 130A, 130B can operate independently in that each outcome for each play of the first wagering game 130A is randomly generated independently from each outcome for each play of the second wagering game 130B. By way of example, and not limitation, on a particular play of the wagering games 130A, 130B, e.g., when a wager is placed and a spin button is pressed, the first set of reels 121A-125A spin and stop to reveal a randomly selected combination of symbols in the first array 132A which are evaluated for winning combinations, and the second set of reels 121B-125B spin and stop to reveal a randomly selected combination of symbols in the second array 132B which are evaluated for winning combinations. Each of the wagering games 130A, 130B may be independently operable in that play of the wagering games 130A, 130B may be wholly independent or, in some configurations, one or more of the wagering games 130A, 130B, or the outcomes or partial outcomes of one or more of the wagering games 130A, 130B, may influence the outcomes or partial outcomes or other aspects of one or more other of wagering games 130A, 130B.

The primary display device 114 also includes one or more real-time event display windows 150 and 152 for simultaneously or substantially simultaneously displaying one or more real-time events during play of the wagering games 130A, 130B. These real-time event may take on various forms, such as live television events (including those with built-in broadcast delays) and prerecorded television events, as well as non-televised events (e.g., movies, non-televised sporting events, etc.) and other real-time events that may be recorded and/or transmitted for display via the primary display device 114. In some more specific examples, the real-time event may be a live or prerecorded sporting event (e.g., baseball game, football game, hockey game, basketball game, soccer game, etc.), a live or prerecorded television show (e.g., Saturday Night Live™, Star Trek™, The Late Show™, etc.), a live or prerecorded game show (e.g., Wheel of Fortune™, Jeopardy™, Family Feud™, etc.), or a live or prerecorded “reality” television show, such as competition reality shows (e.g., American Idol™, Dancing with the Stars™, X Factor™, etc.), documentary-style reality shows (e.g., The Real World™, Big Brother™, etc.), and self-improvement or renovation-style reality shows (e.g., The Biggest Loser™, Extreme Makeover: Home Edition™, etc.).

The overarching characteristic of these real-time events is that neither the player nor the gaming system 100 controls the incidents occurring in these events. For instance, neither the player nor the gaming system controls when a point guard of a particular basketball team makes a three-pointer, hits a game-winning jump shot, posts a double-double for a particular live game, and the like. As another example, neither the player nor the gaming system controls when a Klingon ship attacks the U.S.S. Enterprise in a particular episode of Star Trek™, or when a particular contestant is eliminated from an episode of American Idol™. However, the player and/or gaming system 100 may control related, tangential and ancillary aspects of the real-time event (e.g., what to display, when to display, how long to display, sound level, commentary, etc.).

A player may be provided with a menu displayed, for example, in one or more of the real-time event windows 150, 152 which allows the player to review available real-time events, and select one or more real-time events to watch and to potentially associate with aspects of the wagering games 130A, 130B, as will be developed in detail below. In the embodiment illustrated in FIG. 4, the first real-time event window 150 presents the player with a live broadcast (e.g., streaming a live video feed) of an American football game 154. On the right-hand side of the second real-time event window 152, the player is presented with a play-by-play 156 of some of the recent incidents (e.g., five previous plays) occurring in the football game 154 being shown in the first real-time event window 150 and, on the left-hand side, a digital mapping 158 in a playbook-style format of the football game. Generally speaking, the second real-time event window 150 operates to track and profile the incidents occurring in the real-time event. It is also envisioned that one or both of the real-time event windows 150, 152 be operable to provide additional functionality beyond displaying real-time events and corresponding information, such as providing additional wagering games—base games, bonus games, progressive games, community games, etc.—for play by the player, and/or for displaying advertisements, services, emails, alerts, announcements, etc.

In this aspect of the disclosure, a player may be allowed to identify and/or select at least one and, in some preferred embodiments, an assortment of selected/selectable incidents occurring in the real-time event being displayed in the real-time event windows 150, 152. For some implementations, the player will be presented with a predetermined list of incidents (e.g., via a drop-down menu or pop-up window) from which the player may select one or more incidents. Continuing with the football game 154 example of FIG. 4, these incidents may include, as a non-limiting sample: touchdown scored by a selected team and/or a selected player, filed-goal scored by a selected team and/or a selected player, first down achieved by a selected team and/or a selected player, a final game score, a final team score of a selected team, a game and/or team score at predetermined intervals (e.g., at the end of a selected quarter or half), or any incident that has a likelihood of occurring in an Americana football game. Alternatively, the gaming system 100, namely one or more processors associated therewith (e.g., central processing unit (CPU) 30 of FIG. 2), can identify and/or select one or more selected/selectable incidents occurring in the real-time event. As indicated above, any such occurrence of the selected incident(s) in the real-time event are not controlled by the player or the gaming system.

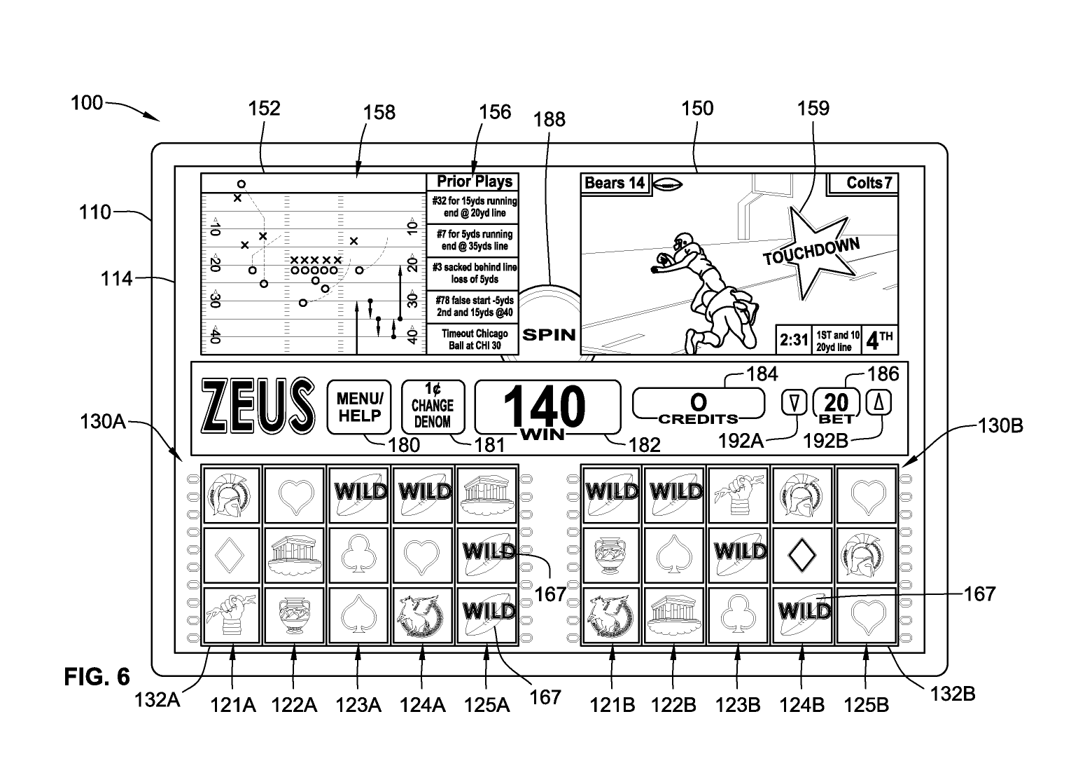

In accordance with the present disclosure, the real-time event(s) displayed in the real-time event windows 150, 152 influences or otherwise affects play of the wagering games 130A, 130B. By way of non-limiting example, incidents occurring in the real-time event modify or trigger specific features of the wagering games. Continuing with the above example, the selected incident(s), once identified, is associated with one or more parameters of the wagering game. For instance, the selected incident may be a particular player (e.g., running back Matt Forte) of a particular team (e.g., the Chicago Bears™ of the National Football League™) scoring a touchdown during a particular live game (e.g., Chicago Bears™ at Indianapolis Colts™), as shown in FIG. 4. This selected incident may be associated with a particular wagering-game parameter—e.g., a triggering event that turns a selected symbol (e.g., the ZEUS symbol 167 in FIG. 4) into a WILD symbol 168 (FIG. 6).

As another example, the player or gaming system can associate a team and/or particular players from a team (e.g., the Chicago Bears™) with the symbol bearing reels 121A-125A of the first wagering game 130A, and associate an opposing team and/or particular players from an opposing team (e.g., the Indianapolis Colts™) with the symbol bearing reels 121B-125B of the second wagering game 130B. The gaming system 100 and/or gaming terminal 110 would receive feedback from the real-time event, which may then be displayed in the second real-time event window 152. A time-delay may be built into the real-time event 154 to allow for editing, mapping, logistics, etc. In accord with this example, when the Chicago Bears™ are in possession of the football (on offense), the first wagering game 130A may be enabled while the second wagering game 130B may be disabled. As another option, when the Chicago Bears™ are in possession of the football (on offense) and a selected incident occurs (e.g., quarterback Jay Cutler throws for a first down) a symbol clump is added to one of the reels 121A-125A, which may be a reel that is designated as Jay Cutler's reel, for one or more subsequent plays of the first wagering game 130A.

The parameter associated with each selected incident may take on a variety of forms, including those enumerated in the previous examples as well as other known wagering-game parameters. In accord with the above slot game representation, the parameter/parameters may include wagering game line count, available paylines, pay table configuration, bonus game eligibility, triggers, and configurations, progressive game eligibility, triggers, and configurations, community game eligibility, triggers, and configurations, changes to episodic content, awarding of persistent state items, such as a coin or clue, that operate to unlock game content, etc. In at least some embodiments, the wagering-game parameter associated with the selected incident affects the expected value of one or both of the wagering games 130A, 130B, affects the volatility of one or both of the wagering games 130A, 130B, or any desired combination thereof. By this means, modifying the at least one parameter will change the expected value/volatility of the wagering game(s).

Some embodiments may require a player to place an additional wager to enable the real-time event game feature. In particular, the gaming system 100 and/or terminal 110 may receive, via a player input device, an indication of a first wager from a player to play or otherwise activate one or both of the wagering games 130A, 130B, and an indication of a second wager, distinct from the first wager, to wager that a selected incident will occur in the real-time event 154. The amount of credits required for the second wager may vary depending on the incident that is selected. For example, if the player wagers that a star midfielder of a highly ranked European football team (e.g., Arsenal F.C. of the English Premier League) will score a goal during a particular match, the wager may be higher than if the player wagers that a relatively unknown center-back defender of that same team will score a goal. In the same vein, the requisite size of the second wager may be tied directly to the probability of a selected incident occurring in a real-time event.

In some embodiments, a player may be required to meet certain eligibility requirements to enable the real-time event game feature. The eligibility may be based on a number of factors, including acquisition of certain game assets (e.g., a key), reaching certain game milestones (e.g., completing a bonus game), exceeding a certain level of wagering activity, being a member of a certain gaming establishment group (e.g., casino player's club), and the like. Alternative arrangements can be designed to automatically enable the real-time event game feature without an input from the player and/or without the player meeting any eligibility requirements.

For at least some embodiments, the second wager for betting on a real-time event can only translate into enhanced game play, and cannot translate directly into monetary reward. In the above football game example, when Matt Forte scores a touchdown during the real-time event 154, all ZEUS symbols 167 are turned into a WILD symbol 168 for one or more subsequent plays of the wagering games 130A, 130B. Turning all ZEUS symbols 167 into a WILD symbol 168 enhances game play by increasing the likelihood of a winning symbol combination in these subsequent plays; however, this change does not provide a guaranteed monetary reward. Optionally, the real-time event game feature may materialize into virtual credits or other alternative representations of value.

According to aspects of the disclosed concepts, a player may be allowed to determine with which wagering-game parameter the selected incident will be associated. This selection may be made from a drop-down menu, pop-up window, help menu, or any other player interface that can present the available options to the player. Alternatively, the gaming system 100, namely one or more processors associated therewith (e.g., central processing unit (CPU) 30 of FIG. 2), can determine which wagering-game parameter will be associated with each selected incident. This latter option may merely comprise the gaming system 30 referring to a lookup table to see which wagering-game parameter or parameters are associated with each selected incident.

The gaming system 100 may be required, in some implementations, to compare a selected incident with a wagering-game parameter to determine if such a pairing is permissible. This is so because, in some embodiments, certain selected incidents may be restricted from being associated with certain game parameters. According to a non-limiting example, the wagering games 130A, 130B each has a variety of wagering game parameters, one or more or all of which can be associated with one or more of a plurality of selected incidents of the real-time event 154. Each selected incident has a respective probability of occurring in the real-time event 154. For some implementations, a selected incident can be associated with a particular wagering-game parameter if it is determined that the respective probability of that selected incident occurring in the real-time event 154 is within a predetermined acceptable probability range for that wagering-game parameter. Using a hockey game as an example, a goaltender scoring during a live game has a very low probability of occurring (only one goaltender, Cam Ward of the Carolina Panthers™, is credited with scoring a goal in the entire 2011-12 season of the National Hockey League™ (NHL)); as such, a selected goalie scoring during a live hockey game can be associated with wagering-game parameters that, once modified, have a relatively large payoff potential in the wagering game (e.g., trigger a large progressive jackpot). The statistical probability of a goalie scoring a goal during a regular-season hockey game (very low probability) would fall within the predetermined acceptable probability range(s) for one or more “low probability” or “very low probability” parameters. By way of comparison, the probability that a star center will score a goal is significantly higher (e.g., numerous centers scored goals during the 2011-12 NHL season, including Evgeni Malkin of the Pittsburgh Penguins™ who scored 60 goals); as such, a selected center scoring during a live hockey game can be restricted to being associated with wager-game parameters that, once modified, have a relatively low payoff potential in the wagering game (e.g., symbol upgrade for one symbol during one play). In this instance, the statistical probability of a center scoring a goal during a regular-season hockey game (high probability) would fall within the predetermined acceptable probability range(s) for one or more “high probability” or “very high probability” parameters, but would not fall within the predetermined acceptable probability range for “low probability” parameters and “very low probability” parameters. These classifications and corresponding ranges can be predefined, for example, via the wagering game manufacturer, the gaming establishment operator, a third-party vendor, or a combination thereof.

Upon occurrence of a selected incident in the real-time event 154 during the simultaneous display of the wagering games 130A, 130B and the real-time event 154, the parameter(s) associated with that selected incident is modified for one or more plays of the wagering game. With continuing reference to FIG. 4, the selected incident(s) includes a selected player (e.g., Matt Forte) of a particular team (e.g., the Chicago Bears™) scoring a touchdown during a particular real-time event (e.g., a live Chicago Bears™ vs. Indianapolis Colts™ football game). This selected incident is associated with a particular wagering-game parameter—e.g., a triggering event that turns all ZEUS symbols 167 into WILD symbols 168 for a subsequent play of the wagering games 130A, 130B. Occurrence of the selected incident can be determined in real-time during the simultaneous display of the wagering games 130A, 130B and the real-time event 154 (e.g., via the information received by the gaming terminal 110 and displayed in the second real-time event window 152). In some embodiments, the selected incident must occur while one or both of the wagering games 130A, 130B are in play. For other embodiments, the selected incident must occur while one or both sets of reels 121A-125A, 121B-125B are spinning. As shown in the first real-time event window 150 in FIG. 4, the selected incident occurred as required. Confirmation of this occurrence can be visually depicted, for example, by a flashing TOUCHDOWN star 159.

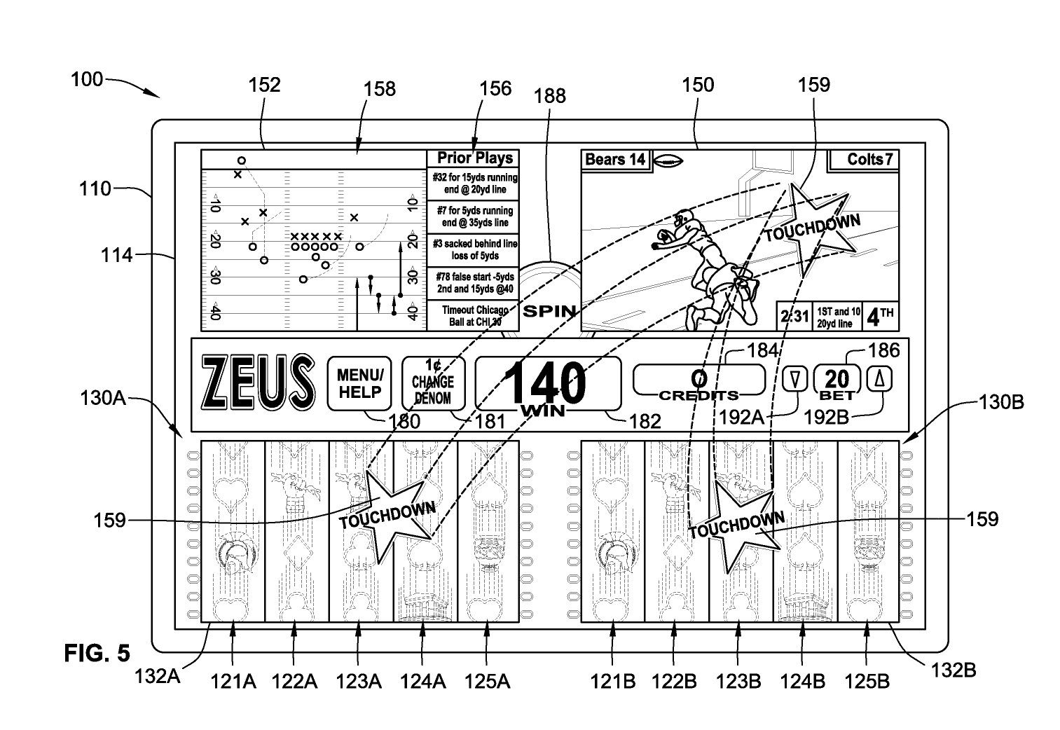

Turning to FIG. 5, a player playing the wagering games 130A, 130B has placed an appropriate wager and commenced a play of the wagering games 130A, 130B. The player has initiated the play of the wagering games 130A, 130B with an appropriate input device, such a spin button 188, and the reels 121A-125A, 121B-125B of the various games 130A, 130B are shown spinning and in motion, prior to stopping to reveal the random outcomes independently selected for each game 130A, 130B. In the embodiment shown in FIGS. 4-6, the reels for each wagering game 130A, 130B can stop one-by-one in a sequential order, which in this embodiment is left to right. Thus, the first (left-most) reel 121A, 121B in each game 130A, 130B is configured to stop first and to display the symbols thereon; the remaining reels 122A-125A, 122B-125B continue spinning. Next, the second reel 122A, 122B (the one directly to the right of the first reel) in each game 130A, 130B stops shortly thereafter to reveal the symbols thereon. This pattern continues until all five reels in each wagering game 130A, 130B have stopped to reveal the randomly selected outcome in each wagering game 130A, 130B. In alternative configurations, the symbol bearing reels 121A-125A, 121B-125B may stop at the same time, in other predetermined orders, in a random order, and with differing time gaps between reels. Illustrated in FIG. 6 is the TOUCHDOWN star 159 of FIG. 5 floating down from the first real-time event window 150 into the arrays 132A, 132B of the first and second wagering games 130A, 130B to visually depict the impending modification of the wagering-game parameter associated with the selected incident which occurred in the real-time event.

With reference to FIG. 6, the reels 121A-125A, 121B-125B have spun and stopped to reveal the randomly selected outcomes of the wagering games 130A, 130B, each comprising symbols on their respective reels 121A-125A, 121B-125B arranged in their respective arrays 132A, 132B. In light of the selected incident occurring in the real-time event 154 during the simultaneous display of the wagering games 130A, 130B and the real-time event 154, all ZEUS symbols 167 have been turned into WILD symbols 168 in each outcome of each wagering game 130A, 130B. In accordance with some aspects of the disclosed concepts, the outcomes of the wagering games 130A, 130B are each evaluated for winning symbol combinations before the aforementioned symbol modification and again after the symbol modification. For other implementations, only the modified outcomes of the wagering games 130A, 130B are each evaluated for winning symbol combinations. In some instances, the player can watch multiple real-time events and be rewarded for selected incidents occurring in both events.

Notably, the various features and aspects associated with the real-time event game feature are not per se limited to slot games; these features and aspects can be applied to other known wagering games, such as poker, blackjack, keno, baccarat, etc. If the wagering game is bingo, for example, and the simultaneously displayed real-time event is soccer, every time a particular player touches the soccer ball a bingo ball is drawn. In addition, or alternatively, every time a particular team scores a goal, a predetermined spot(s) on the bingo card becomes wild. Moreover, the real-time event game feature can be applied to bonus games, progressive games, community games, skill based games, and other complementary wagering game features.

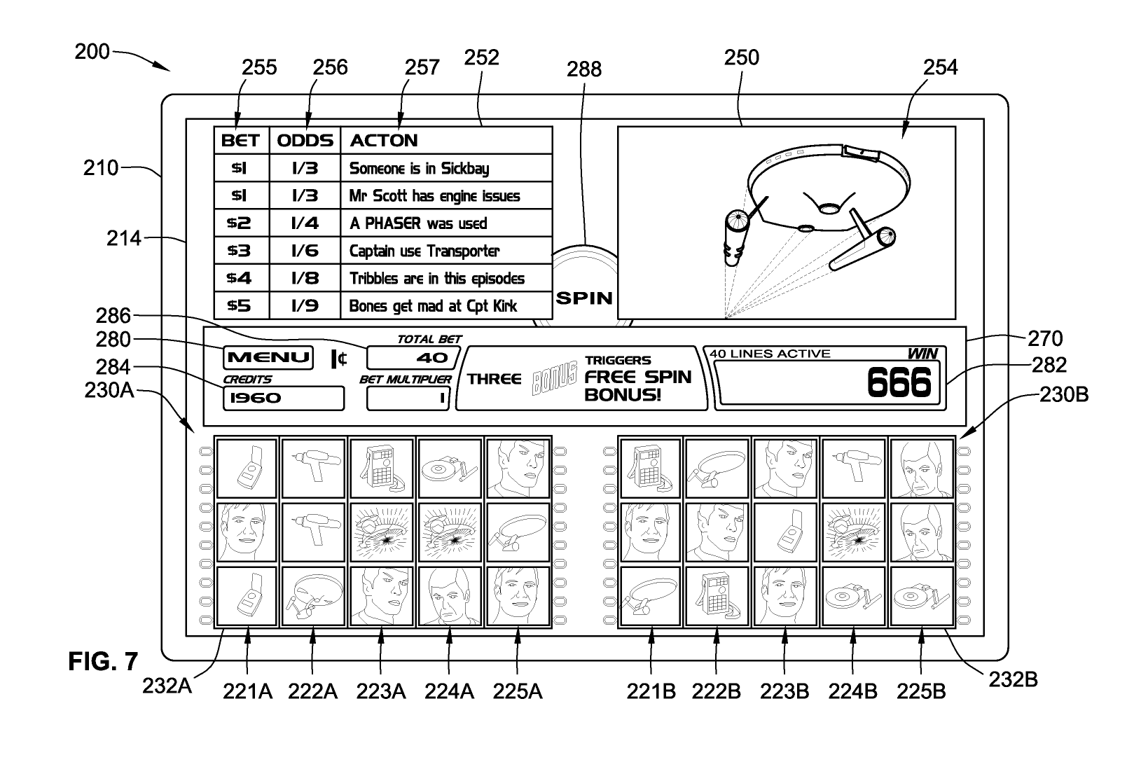

Shown in FIG. 7, wherein like reference numerals refer to like features from the other views, is a screen shot of a game screen from another exemplary wagering game in accordance with aspects of the present disclosure. A primary display device 214 of a gaming machine or terminal 210, which may be part of an exemplary gaming system 200, is shown in FIG. 7. The gaming system 200, gaming terminal 210, and primary display device 214 of FIG. 7 can take on any of the various forms, optional configurations, and functional alternatives described with respect to the other embodiments presented herein, and thus can include any of the corresponding options and features. As such, for brevity and conciseness, much of the related description of these components will be hereinafter omitted.

Like the primary display device 114 of FIGS. 4-6, the primary display device 214 of FIG. 4 displays or otherwise visually depicts a plurality of wagering games, which in this example are first and second slot games 230A and 230B. Each wagering game 230A, 230B comprises a respective plurality of symbol bearing reels 221A-225A and 221B-225B, each of which has a plurality of distinct symbol positions occupied by a number of symbols. These symbols may include any variety of graphical symbols, emblems, elements, or representations, including symbols that are associated with one or more themes of the gaming terminal 210 (e.g., a Star Trek™ theme). The symbols on the reels 221A-225A, 221B-225B are arranged in first and second arrays 232A and 232B, respectively, which in this embodiment are 3×5 matrices (i.e., three rows by five columns) of symbols. The reels 221A-225A, 221B-225B are varied (e.g., spun and stopped) to reveal combinations of symbols in the arrays 232A, 232B, which represent randomly selected outcomes of the wagering games 230A, 230B, that are evaluated for winning symbol combinations. Unless otherwise expressly or logically prohibited, the wagering games 230A, 230B may include any of the optional features or alternative aspects described above with respect to the wagering games 130A, 130B in FIGS. 4-6.

As seen in FIG. 7, the primary display 214 further includes certain display features for providing information and options to a player. Similar to the embodiments presented in FIGS. 4-6, the primary display 214 of FIG. 7 provides the player with a control bar 270 for presenting information and player-selectable options to the player. These display features may include any of the options described above with respect to FIG. 3 and FIG. 4, including a MENU button 280, a WIN meter 282, a CREDITS meter 284, and a TOTAL BET meter 286. Each of these display features may functionally similar to the corresponding meters and buttons described above with respect to the primary display 114 in FIG. 4. In this vein, the additional and alternative display features discussed above may also be incorporated into the primary display 214 of FIG. 7. Moreover, the control bar 270, like the control bar 170, may be operable to control aspects of both wagering games 130A and 130B, whether it be simultaneously, independently, or both.

The primary display device 214 of FIG. 7 also includes one or more real-time event display windows 250 and 252 for simultaneously or substantially simultaneously displaying one or more real-time events during play of the wagering games 230A, 230B. These real-time events may take on any of the various forms and alternatives described above during the description of FIGS. 4-6. Like those real-time events, the real-time events (and related information) displayed by the display windows 250, 252 of FIG. 7 can be characterized in that neither the player nor the gaming system 200 controls the incidents occurring in these events. In this regard, the player and/or gaming system 200 may control related, tangential and ancillary aspects of the real-time event.

In the embodiment illustrated in FIG. 7, the first real-time event window 250 presents the player with a prerecorded episode 254 of a well-known television show—Star Trek™. As indicated above, the real-time event could also be a live television show (e.g., a television production broadcast in real-time, as events happen, in the present). The second real-time event window 252 presents the player with a number of player-selectable incidents that may occur in the real-time event 254. Specifically, on the right-hand side of window 252, the player is presented with an ACTION list 257 of player-selectable incidents, an ODDS list 256 (center of window 252) with the corresponding probability that each of those events will occur in the concurrently displayed episode 254, and a BET list 255 (left-hand side of window 252) with the corresponding wager for selecting an incident in the ACTION list 257 and thereby activating the real-time event game feature. The corresponding probabilities set forth in the ODDS list 256 of FIG. 7 can be randomly generated by the gaming system 200 and/or gaming terminal 210, can be provided by the distributor of the wagering games, may be based on a statistical analysis of other related real-time events (e.g., all episodes of the Star Trek: The Original Series), or any combination thereof.

A player may be allowed to identify and/or select one and, in some preferred embodiments, an assortment of the selectable incidents presented in the ACTION list 257 that may occur in the real-time event 254 being displayed in the real-time event windows 250. In the illustrated example, the player is required to submit a secondary wager of $2, in addition to any primary wagers submitted to play the wagering game(s) 230A, 230B, to bet that a phaser will be used during the displayed portion of the prerecorded episode 254 of Star Trek™. As another example, the player is required to submit a secondary wager of $4 to bet that Tribbles (fictional characters) will appear during the displayed portion of the prerecorded episode 254 of Star Trek™. Optionally, the gaming system 200 can identify, select or otherwise activate one or more selected incidents that may occur in the real-time event.

As with the examples discussed above with reference to FIGS. 4-6, the real-time event displayed in the real-time event windows 250, 252 influences or otherwise affects play of the wagering games 230A, 230B. Each selected incident, once activated by a player, is associated with one or more parameters of the wagering game. For instance, the selected incident may be a particular character (e.g., Dr. Leonard “Bones” McCoy) performing a specific action (e.g., getting angry at Captain James T. Kirk) in a particular episode (e.g., the “All Our Yesterdays” episode) of a particular television show (e.g., Star Trek: The Original Series). This selected incident may be associated with a particular wagering-game parameter—e.g., a triggering event that makes the player eligible for a particular progressive jackpot. In this regard, each of the other player-selectable incidents enumerated in the ACTION list 257 can be associated with a respective triggering event for a respective progressive jackpot. As an optional alternative, each of the player-selectable incidents itemized in the ACTION list 257 can be associated with a distinct type of wagering-game parameter—e.g., one is associated with a symbol-clumping-triggering feature, one is associated with a symbol-upgrade-triggering feature, one is associated with a bonus-game-triggering feature, one is associated with a community-game-triggering feature, and one is associated with a progressive-jackpot-triggering feature. In some embodiments, the player may be allowed to choose which wagering-game parameter is associated with which incident.

Upon occurrence of a selected incident in the real-time event 254 during the simultaneous display of the wagering games 230A, 230B and the real-time event 254, the parameter(s) associated with that selected incident is modified for one or more plays of the wagering game. Determining if a selected incident has occurred may be conducted in real-time (e.g., while the real-time event is being displayed to the player), or may be conducted in advance (e.g., each episode is reviewed and mapped before being displayed to the player). The determination may be made “internally” by the gaming system 100 or gaming terminal 210, or made “externally” and provided by a third party vendor or source. Confirmation of any such occurrence can be provided by a visual indicator, audible indicator, tactile indicator, or any other reasonably pertinent means. It is envisioned that more than one selected incident will occur in the real-time event 254 during the simultaneous display of the wagering games 230A, 230B and the real-time event 254; the parameter(s) associated with all of the selected incident can be modified individually or collectively for the same or different plays of the wagering game(s) 230A, 230B.

Simultaneously displayed real-time events 254 may affect other aspects of the wagering games 230A, 230B besides just wagering-game parameters. For instance, one or more reel symbols could be tied to a real-time event, or specified aspects within a real-time event, such that those symbols or certain animations associated with those symbols would only be active while the real-time event or a specific aspect within that event is being displayed. As a non-limiting example, a Spock symbol and, thus, corresponding winning symbol combinations would only be available on the symbol bearing reels of a wagering game when a Star Trek™ episode is being simultaneously displayed and, in some embodiments, when Spock is in the scene being simultaneously displayed. The real-time event 254 could also trigger certain dedicated advertising features, such as advertisements and/or free tickets for a soon-to-be released Star Trek movie. In another example, when the primary display device 214 is streaming a live English Premier League football match between Arsenal F.C. and Manchester United F.C., the first wagering game 230A, including the symbols and array, may be transformed into an “Arsenal Slot Matrix” with corresponding colors, symbols, sponsors, etc., while the second wagering game 230B, including the symbols and array, may be transformed into a “Manchester United Slot Matrix” with corresponding colors, symbols, sponsors, etc. In this regard, every time Arsenal F.C. scores a goal, the primary display device 214 can flash branding information for Nike or other Arsenal sponsors. Using player tracking technology, a patron who continually watches a specific real-time event (e.g., Arsenal F.C. matches) could be awarded with related tickets, paraphernalia, etc.

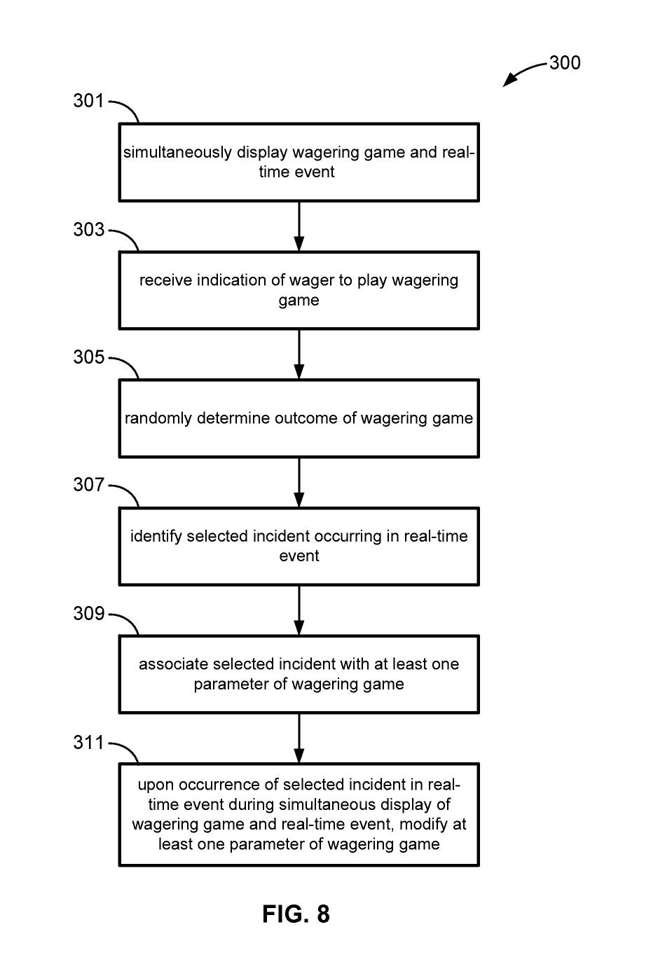

With reference now to the flow chart of FIG. 8, an improved method of conducting a wagering game on a gaming terminal and/or a gaming system, such as those shown in FIGS. 1-7, for example, is generally described at 300 in accordance with aspects of the present disclosure. FIG. 8 can be representative of an algorithm that corresponds to at least some instructions that can be stored, for example, in main memory 32 of FIG. 2, and executed, for example, by the CPU 30 and/or external system(s) 48 of FIG. 2 to perform any or all of the above or below described functions associated with the disclosed concepts. The method 300 will be described with reference to the various aspects and features shown in the drawings; such reference is being provided purely by way of explanation and clarification.

The method 300 begins at block 301 with simultaneously displaying one or more wagering games with one or more real-time events. These wagering games and real-time events can take on any of the various forms, optional features and functional alternatives described above. For instance, the real-time event may be a live television event or a prerecorded television event. The simultaneous display of the wagering game(s) and real-time event(s) may be preceded, accompanied, or followed by receiving (e.g., via an input device such as touch screen 18, bill validator 22, information reader/writer 24, etc.) an indication of a wager to play one or more of the wagering games, as indicated at block 603.

At block 305, an outcome of the wagering game is randomly determined. For instance, an outcome may be randomly determined for a base-game portion of each displayed wagering game. This may include, as indicated above, an RNG generating a random number, game logic for determining the outcome based on the randomly generated number, and the CPU 30, the external system 48, or both, in alternative embodiments, operating to execute a wagering game program, and game assets (e.g., art, sound, etc.) for presenting the determined outcome to a player in a visual manner. The base-game outcome for each wagering game can be visually represented by a plurality of symbols arranged on a display device, such as the symbol-bearing reels shown in FIGS. 4-7.

At block 307, the method 300 includes identifying one or more selected incidents that may occur in the real-time event(s) being simultaneously displayed with the wagering game(s). As discussed during the description of the illustrated examples, occurrence of a selected incident in a real-time event is not controlled by the player or the gaming terminal/system. Block 307 may include receiving, via at least one of one or more input devices, a player input to select at least one selected incident. Moreover, block 307 may include receiving, via at least one of one or more input devices, an indication of a second wager from a player to wager that a selected incident will occur in the real-time event.

The method 300 of FIG. 8 also includes associating each selected incident with at least one parameter of at least one of the wagering games, as indicated at block 309. Associating a selected incident with a parameter may be responsive to a secondary wager received from the player. Optionally, associating a selected incident with a parameter of a wagering game may first require determining that the probability of the selected incident occurring in the real-time event is within a predetermined acceptable probability range for the parameter. In some embodiments, the parameter affects the expected value of the wagering game such that the modifying the parameter changes the expected value of the wagering game. In some embodiments, the parameter affects the volatility of the wagering game such that modifying the parameter changes the volatility of the wagering game. The manner in which a selected incident is applied (i.e., the parameter with which it is associated) can be controlled by the gaming establishment, the gaming terminal, the wagering game manufacturer, the player, or any combination thereof.

Other aspects/parameters of a wagering game may need to be modified to offset changes caused by a real-time event. For example, if the simultaneously displayed real-time event includes a large number of occurrences of a selected incident (e.g., a selected basketball player is making a large number of three-point jump shots, each of which triggers a free spin), the wagering game/terminal/system may offset this outcome, and thereby maintain a predetermined payback percentage and/or a predetermined expected value, by reducing the number of winning outcomes during regular play of the wagering game or by reducing the size of any winning outcomes in each free spin.

Upon occurrence of a selected incident in the real-time event during the simultaneous display of the wagering game(s) and the real-time event(s), block 311 includes modifying the parameter associated with the selected incident for at least one play of the wagering game. For instance, one of the wagering games may include a plurality of bonus games, each of which is associated with a respective triggering event (e.g., a predetermined symbol combination) that triggers that bonus game. A selected incident may be associated with each one of these bonus games such that occurrence of a selected incident in the real-time event during the simultaneous display of the wagering game and the real-time event triggers the respective bonus game associated with that selected incident. In some embodiments, each of the bonus games has a respective expected value, wherein the expected values of the bonus games are substantially neutral. A respective probability of triggering each of the bonus games can be adjusted to keep the expected values between the bonus games substantially equal.

As another example, the wagering game may include a plurality of progressive jackpots, each of which is associated with a respective triggering event which makes the player eligible for that progressive jackpot. A selected incident may be associated with each one of the progressive jackpots such that occurrence of a selected incident in the real-time event during the simultaneous display makes the player eligible to win the respective progressive jackpot associated with that selected incident. In some embodiments, each of the progressive jackpots has a respective expected value, wherein the expected values of the progressive jackpots are substantially neutral. A respective probability of triggering each of the progressive jackpots can be adjusted to keep the expected values between the progressive jackpots substantially equal.

For some implementations, one or more of the wagering games can each be designated as “an offensive game” while one or more of the wagering games can each be designated as “a defensive game,” with the offensive games being associated with an “offensive progressive jackpot” and the defensive games being associated with a defensive progressive jackpot. When a selected team is on offense, the player participates in the “offensive” wagering games and attempts to win an offensive progressive jackpot. While the selected team is on defense, the player participates in the “defensive” wagering games and attempts to win a defensive progressive jackpot. In so doing, the real-time event alters which progressive jackpot/game the player is eligible to play/win and when the player is eligible to play/win. This same concept can be applied to eligibility for eligibility/triggering of bonus games, community events, etc.

According to another example, the parameter may be the predetermined volatility of one or both of the wagering games. In this instance, the selected incident can be the current status of the real-time event such that the predetermined volatility of the wagering game is varied based upon the current status of the real-time event. By way of non-limiting example, if the current status of the real-time event is any one of a plurality of predefined exciting states (e.g., the fourth quarter of an NFL playoff game where the teams are seven points or less apart), the method responsively switches the volatility of the wagering game to a high-volatility mode. Contrastingly, if the current status of the real-time event is any one of a plurality of predefined unexciting (“dull”) states (e.g., the fourth quarter of an NFL preseason game or a regular season game where the teams more than 21 points apart), the volatility of the wagering game is responsively switched into a low-volatility mode. I'm mildly paying attention to my soccer game when it's a 5 nothing game. In a hockey game example, if it's the third period between the player's favorite team and their arch rivals and the score is 1-0, the current status of this game could be predefined as exciting as the player would be watching intently. The gaming system/terminal would switch to a high-volatility mode (e.g., less frequent wins with larger payouts) so that the player is only distracted by big events in the wagering games. Contrastingly, if the game if 4-0 with five minutes left in the third period, the current status of this game could be predefined as unexciting as the player would not be watching as intently. Responsively, the gaming system/terminal would switch to a low-volatility mode (e.g., more frequent wins with smaller payouts) so that the player is concentrating more on the wagering games.

In accord with aspects of the disclosed concepts, the real-time event could include local events occurring within the gaming establishment or a neighboring gaming establishment. For example, the simultaneously displayed real-time event could be a poker tournament being conducted within the same gaming establishment as the player of the wagering games. As another example, the simultaneously displayed real-time event could be the wagering activities (e.g., slot play) of another player within the same gaming establishment as the player of the wagering games. In this example, the reel outcomes and wagering activities of the other player's slot game is simultaneously displayed in real-time. The player can then select or otherwise activate incidents that may occur in the other player's slot game to initiate or modify game play in their slot game.

An optional feature that may be incorporated into implementations with sports-game-based real-time events is a “season tickets game feature” which allows the player to purchase, qualify for, or otherwise commit to a specific team in a specific sport for a specific season. For example, a player's favorite tame may be Manchester United F.C.; the player may be provided with the option of buying a “season ticket” to play wagering games with all Manchester United F.C. matches as their designated real-time event. The season tickets game feature may include a persistent state feature where benefits conferred on a player during gameplay on one day can carry over to gameplay on subsequent days. Gameplay can be modified as the season progresses to include elements based on the season. For instance, Manchester United F.C. winning (or losing) over the course of the season (i.e., team standings) can affect payback percentage, volatility, secondary wagering requirements, advertising etc. In addition, injured players may be removed from reel symbols and available player-selectable incidents. Playoff games may introduce features not otherwise available during the regular season.

One or more of the display windows provided on the display devices can display features other than wagering games and real-time events. For example, a player may be allowed to access the internet via their gaming terminal. This may include accessing a popular social networking website, such as Facebook® and Twitter®. In so doing, player can post their game play, or the gaming terminal can push portions of their gameplay, to these websites. In a non-limiting example, the player may have the Facebook® page of the Detroit Tigers™ displayed on their terminal; as the selected incidents within a simultaneously displayed Tigers game affects a player's wagering game, the gaming terminal/system can push updates to that particular page.

In some embodiments, the method 300 includes at least those steps enumerated above. It is also within the scope and spirit of the present invention to omit steps, include additional steps, and/or modify the order presented above. It should be further noted that the method 300 represents a single play of a wagering game. However, it is expected that the method 300 be applied in a systematic and repetitive manner.

Aspects of this disclosure can be implemented, in some embodiments, through a computer-executable program of instructions, such as program modules, generally referred to as software applications or application programs executed by a computer. The software can include, in non-limiting examples, routines, programs, objects, components, and data structures that perform particular tasks or implement particular abstract data types. The software forms an interface to allow a computer to react according to a source of input. The software can also cooperate with other code segments to initiate a variety of tasks in response to data received in conjunction with the source of the received data. The software can be stored on any of a variety of memory media, such as CD-ROM, magnetic disk, bubble memory, and semiconductor memory (e.g., various types of RAM or ROM).

Moreover, numerous aspects of the present disclosure can be practiced with a variety of computer-system and computer-network configurations, including hand-held devices, multiprocessor systems, microprocessor-based or programmable-consumer electronics, minicomputers, mainframe computers, and the like. In addition, aspects of the present disclosure can be practiced in distributed-computing environments where tasks are performed by remote-processing devices that are linked through a communications network. In a distributed-computing environment, program modules can be located in both local and remote computer-storage media including memory storage devices. Aspects of the present disclosure can therefore, be implemented in connection with various hardware, software or a combination thereof, in a computer system or other processing system.

Any of the methods described herein can include machine readable instructions for execution by: (a) a processor, (b) a controller, and/or (c) any other suitable processing device. Any algorithm, software, or method disclosed herein can be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it can be implemented by an application specific integrated circuit (ASIC), a programmable logic device (PLD), a field programmable logic device (FPLD), discrete logic, etc.). Also, some or all of the machine readable instructions represented in any flowchart depicted herein can be implemented manually. Further, although specific algorithms are described with reference to flowcharts depicted herein, persons of ordinary skill in the art will readily appreciate that many other methods of implementing the example machine readable instructions can alternatively be used. For example, the order of execution of the blocks can be changed, and/or some of the blocks described can be changed, eliminated, or combined.

It should be noted that the algorithms illustrated and discussed herein as having various modules or blocks that perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While many representative embodiments and exemplary modes for carrying out the present invention have been described in detail above, those familiar with the art to which this invention relates will recognize various alternative designs and embodiments for practicing the invention within the scope of the appended claims.

What is claimed is:

1. A gaming system for a player to play a wagering game, the gaming system comprising:
one or more display devices;
one or more input devices;
one or more processors; and
one or more memory devices storing instructions that, when executed by at least one of the one or more processors, cause the gaming system to:
simultaneously display, via at least one of the one or more display devices, the wagering game and a real-time event;
randomly determine an outcome of the wagering game;
identify at least one selected incident occurring in the real-time event, occurrence of the at least one selected incident in the real-time event not being controlled by the player or the gaming system;
associate the at least one selected incident with at least one parameter of the wagering game; and
upon occurrence of the at least one selected incident in the real-time event during the simultaneous display of the wagering game and the real-time event, modify the at least one parameter for at least one play of the wagering game.

2. The gaming system of claim 1, wherein the at least one parameter affects the expected value of the wagering game such that the modifying the at least one parameter changes the expected value of the wagering game.

3. The gaming system of claim 1, wherein the wagering game includes a plurality of bonus games, the at least one parameter includes a plurality of triggering events each of which triggers a respective one of the bonus games, and the at least one selected incident includes a plurality of selected incidents in the real-time event, each of the selected incidents being associated with a respective one of the bonus games such that occurrence of one of the selected incidents in the real-time event during the simultaneous display of the wagering game and the real-time event triggers the respective bonus game associated with that one of the selected incidents.

4. The gaming system of claim 3, wherein each of the bonus games has a respective expected value, the expected values of the bonus games being substantially neutral, and wherein a respective probability of triggering each of the bonus games is adjusted to maintain the expected values between the bonus games substantially equal.

5. The gaming system of claim 1, wherein the wagering game includes a plurality of progressive jackpots, the at least one parameter includes a plurality of triggering events each of which makes the player eligible for a respective one of the progressive jackpots, and the at least one selected incident includes a plurality of selected incidents, each of the selected incidents being associated with a respective one of the progressive jackpots such that occurrence of one of the selected incidents in the real-time event during the simultaneous display makes the player eligible to win the respective progressive jackpot associated with that one of the selected incidents.

6. The gaming system of claim 5, wherein each of the progressive jackpots has a respective expected value, the expected values of the progressive jackpots being substantially neutral, and wherein a respective probability of triggering each of the progressive jackpots is adjusted to maintain the expected values between the progressive jackpots substantially equal.

7. The gaming system of claim 1, wherein the at least one parameter is a predetermined volatility of the wagering game and the at least one selected incident is a current status of the real-time event such that the predetermined volatility of the wagering game is varied based upon the current status of the real-time event.

8. The gaming system of claim 7, wherein, responsive to the current status of the real-time event being any one of a plurality of predefined exciting states, the predetermined volatility of the wagering game is switched into a high-volatility mode.

9. The gaming system of claim 7, wherein, responsive to the current status of the real-time event being any one of a plurality of predefined unexciting states, the volatility of the wagering game is switched into a low-volatility mode.

10. The gaming system of claim 1, wherein the at least one parameter includes a plurality of wagering game parameters and the at least one selected incident of the real-time event includes a plurality of selected incidents, each of the selected incidents having a respective probability of occurring in the real-time event.

11. The gaming system of claim 10, wherein each of the selected incidents is associated with a respective one of the wagering game parameters if it is determined that the respective probability of the selected incident occurring in the real-time event is within a respective predetermined acceptable probability range for the wagering game parameter.

12. The gaming system of claim 1, wherein occurrence of the at least one selected incident is determined in real-time during the simultaneous display of the wagering game and the real-time event.

13. The gaming system of claim 1, wherein the associating the at least one selected incident with the at least one parameter of the wagering game is responsive to a secondary wager received from the player.

14. The gaming system of claim 1, wherein the identifying the at least one selected incident is responsive to a player input received from the player to select the at least one selected incident.

15. The gaming system of claim 1, wherein the real-time event is a live television event.

16. The gaming system of claim 1, wherein the real-time event is a prerecorded television event.

17. One or more physical machine-readable storage media including instructions which, when executed by one or more processors, cause the one or more processors to perform operations comprising:
direct one or more display devices to simultaneously display a wagering game and a real-time event;
receive an indication of a wager from a player to play the wagering game;
randomly determine an outcome of the wagering game;
identify a selected incident occurring in the real-time event, occurrence of the selected incident in the real-time event not being controlled by the player or the one or more processors;
associate the selected incident with a parameter of the wagering game; and
upon occurrence of the selected incident in the real-time event during the simultaneous display of the wagering game and the real-time event, modify the parameter for a play of the wagering game.

18. A computer-implemented method of conducting a wagering on a gaming system with one or more processors and one or more display devices, the method comprising:
simultaneously displaying, via at least one of the one or more display devices, a wagering game and a real-time event;
receiving an indication of a wager from a player to play the wagering game;
randomly determining, via at least one of the one or more processors, an outcome of the wagering game;
identifying at least one selected incident occurring in the real-time event, occurrence of the at least one selected incident in the real-time event not being controlled by the player or the gaming system;
associating the at least one selected incident with at least one parameter of the wagering game; and
upon occurrence of the at least one selected incident in the real-time event during the simultaneous display of the wagering game and the real-time event, modifying the at least one parameter for at least one play of the wagering game.

19. The method of claim 18, wherein the at least one parameter affects the expected value of the wagering game such that the modifying the at least one parameter changes the expected value of the wagering game.

20. The method of claim 18, wherein the at least one parameter is a predetermined volatility of the wagering game and the at least one selected incident is a current status of the real-time event such that the predetermined volatility of the wagering game is varied based upon the current status of the real-time event.

21. The method of claim 18, wherein the at least one parameter includes a plurality of wagering game parameters and the at least one selected incident of the real-time event includes a plurality of selected incidents, each of the selected incidents having a respective probability of occurring in the real-time event.

22. The method of claim 21, wherein each of the selected incidents is associated with a respective one of the wagering game parameters if it is determined that the respective probability of the selected incident occurring in the real-time event is within a respective predetermined acceptable probability range for the wagering game parameter.

23. The method of claim 17, wherein occurrence of the at least one selected incident is determined in real-time during the simultaneous display of the wagering game and the real-time event.

24. A method of conducting a wagering on a gaming system with one or more processors and one or more display devices, the method comprising:
simultaneously displaying, via a single one of the one or more display devices, the wagering game and the real-time event;
randomly determining, via at least one of the one or more processors, an outcome of the wagering game, the wagering game having a parameter that affects the expected value of the wagering game;
determining a probability of a selected incident occurring in the real-time event, occurrence of the selected incident in the real-time event not being controlled by the player or the one or more processors of the gaming system;
associating the selected incident with the parameter of the wagering game if it is determined that the probability of the selected incident occurring in the real-time event is within a predetermined acceptable probability range for the parameter; and
responsive to an occurrence of the selected incident in the real-time event during the simultaneous display, modifying the wagering game parameter such that the expected value of the wagering game changes for a subsequent play of the wagering game.

25. A method of conducting a wagering on a gaming system with one or more processors, one or more input devices, and one or more display devices, the method comprising:
simultaneously displaying, via at least one of the one or more display devices, the wagering game and a real-time event;
receiving, via at least one of the one or more input devices, an indication of a wager from a player to play the wagering game;
randomly determining, via at least one of the one or more processors, an outcome of the wagering game;
receiving, via at least one of the one or more input devices, an indication of a second wager from a player to wager that a selected incident will occur in the real-time event, occurrence of the selected incident in the real-time event not being controlled by the player or the one or more processors of the gaming system;
associating the selected incident with a parameter of the wagering game; and
responsive to an occurrence of the selected incident in the real-time event during the simultaneous display of the wagering game and the real-time event, modifying the parameter for a play of the wagering game.
